(19) United States
(12) Patent Application Publication
(10) Pub. No.: US 2011/0021051 A1
(43) Pub. Date: Jan. 27, 2011

(54) ADAPTER

(76) Inventor: Pierre-Andre Larocque, Sainte-Adele (CA)

Correspondence Address: IPAXIO S.E.N.C, 2250 St. Martin Blvd East, Suite 100, Laval, QC, H7E 5A4, CA

(21) Appl. No.: 12/934,226

(22) PCT Filed: Mar. 26, 2009
(86) PCT No.: PCT/CA2009/000363

§ 371 Date: Sep. 23, 2010

(30) Foreign Application Priority Data
Mar. 26, 2008 (CA) 2627280

(51) Int. Cl. H01R 33/08

(52) U.S. Cl. 439/236

(57) ABSTRACT

The present invention provides an adapter allowing them to be installed into a lamp fixture primarily conceived for fluorescent tubes. Certain types of neon tubes consume significantly less electricity while operating than fluorescent tubes and have a longer lifetime than fluorescent tubes. The adapter comprises a pin holder from which one or more pins extend and has means to electrically connect the electrode of the neon tube to the lamp fixture. An adapter is installed on each extremity of a neon tube prior to the installation of the neon tube in a modified fluorescent lamp fixture. Finally, neon tubes do not comprise or at the very least comprise significantly less mercury (which is widely recognized as being a health treat) than is found in fluorescent tubes.

### CROSS-REFERENCE TO RELATED APPLICATIONS

The present patent application claims the benefits of priority of commonly assigned Canadian Patent Application No. 2,627,280, entitled “ADAPTER” and filed at the Canadian Patent Office on Mar. 26, 2009.

### FIELD OF THE INVENTION

The present invention generally relates to lighting devices, more particularly to an adapter to connect a neon tube in a fluorescent lamp fixture.

### BACKGROUND OF THE INVENTION

A fluorescent lamp or fluorescent tube is a gas-discharge lamp that uses electricity to excite mercury vapor in neutral gas such as argon or neon, resulting in a plasma that produces short-wave ultraviolet light. This light then causes phosphor to fluoresce, producing visible light. As used herein, the term “neon tube” refers to an elongated cold cathode gas discharge tube containing an ionizable gas (including neon, argon, krypton and other gases or combinations). The tube has a pair of cathode elements passing through the glass at each end of the tube that are in contact with the gas. The cathode elements are connected to a power supply source, providing a high voltage between the cathode elements thus causing the gas to ionize and glow and producing the desired illumination. The traditional fluorescent tubes are excluded from this definition. Traditional fluorescents tubes refer to a lighting device usually of the hot cathode type, which generates ultraviolet light emitted by mercury vapor so that a phosphor coating absorbs the energy of the ultraviolet light and produces visible light. “Neon” tubes do not usually contain mercury (or at the very least significantly less than fluorescent tubes).

In addition to neon, argon (another noble gas) is the most commonly-used gas used in gas discharge lighting. Argon is used because it is a source of ultraviolet light, as well as producing visible light with a deep-blue color. In fluorescent lamps, the combination of mercury and argon generates large amounts of ultraviolet light. As it is known, mercury is a health treat and therefore causes a problem with the elimination of fluorescent tubes. Indeed the used tubes have to be collected for a proper disposal. However, in many places, there is no means to collect these used tubes. Thus, mercury contained in fluorescent tubes is often transmitted into the environment when the fluorescent tubes are discarded.

In some states of the United States it is forbidden to throw away fluorescent tubes with the “normal” garbage. The fluorescent tubes are collected to prevent the discharge of mercury in the environment, generating high costs for these procedures. Considering that a large number of commercial buildings are using fluorescent tubes for lighting, there is a substantial amount of mercury generated.

“Neon” signs are luminous-tube signs that contain neon or other inert gases at a low pressure. Applying a high voltage (usually at least a few thousand volts) makes the gas glow brightly. Gas discharge lighting is seen most frequently in “neon” signs and decorative lighting. While neon gas is used in some of these tubular lamps, other gases are used to produce light in colors other than the red-orange color that neon produces when electricity passes through it. It is indeed possible to obtain a white color with a “neon” tube.

Neon gas discharge lighting devices are also called “cold cathode” devices. This is because the cathodes, metal conductors on the inside of each end of the tube, are not heated to encourage electrons to travel through the gas as for fluorescent tubes. Instead, a voltage greater than the total resistance of the gas of all the tubes in the circuit is typically used.

A neon light requires a high voltage to start, but often consumes only use a few milliamperes of current while operating. Because of the low current used, the electricity consumed by “neon” lighting is less than by fluorescent lighting. As mentioned before, considering the quantity of fluorescent used in commercial buildings, this reduction in consumption of electricity represents a substantial amount. Furthermore, the neon tubes have a longer lifetime than the fluorescent tubes.

Neon signs comprise glass tubes which are bent into various configurations and which have electrodes sealed into their opposite ends. The color of the light which is emitted when a high electric potential is applied across the electrodes depends on the particular inert gas with which the tube is filled. Argon, krypton and neon are the most commonly used gases, but for the sake of brevity, all light emitting gas filled tubes (excluding fluorescent tubes) to which the new adapter is applicable will be called neon tubes herein.

The economic benefit that could be achieved with an adapter to use neon tubes instead of fluorescent tubes in standard fluorescent fixtures, particularly in a commercial environment, is substantial.

### OBJECTS OF THE INVENTION

It is an object of the present invention to provide a lighting device allowing a substantial economy in electrical consumption.

It is another object to provide an adapter allowing neon tubes to be connected into a fluorescent lamp fixture.

It is a further object to provide an adapter which is very simple to install and that do not need any particular tools or knowledge.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The aforesaid and other objectives of the present invention are realized by generally providing an adapter for a cold cathode gas discharge tube of the type comprising a tube containing a noble gas but excluding fluorescent tubes, a pair of electrodes located inside the tube and wires extending through the tube to electrically connect each the electrode to said adapter, the adapter being used to install the neon tube into a lighting fixture of the type adapted to receive traditional fluorescent tubes, the fixture having lamp sockets, the adapter comprising a pin holder, the pin holder comprising at least one pin which is complementary to the lamp sockets, means to attach the pin holder to the discharge tube, and means to electrically connect the pin to the electrode of the discharge tube.

In another embodiment, the present invention provides an adapter for a gas tube of the type comprising a tube containing a noble gas which produce visible light when ionized, a pair of electrodes located inside the tube near a respective end of the tube and wires extending through the tube while electrically connecting each the electrode, the adapter being used to install the gas tube into a lighting fixture of the type adapted to receive traditional fluorescents tubes, the fixture having lamp sockets, the adapter comprising a pin holder, the pin holder comprising at least one pin which is complementary to the lamp sockets, means to attach the pin holder to the gas tube, and means to electrically connect the pin to the electrode of the gas tube.

In a further embodiment, the present invention provides an adapter for a cold cathode gas discharge tube of the type comprising a tube containing a noble gas, an electrode located inside the tube near each tube end and wires extending through the tube to electrically connect each electrode, the adapter being used to install the discharge tube into a lighting fixture of the type adapted to receive fluorescents tubes, the lamp having lamp sockets, the adapter comprising a collar having a complementary shape to that of the tube, the collar adapted to receive one of the tube ends, means to attach the pin holder to the discharge tube, a pin holder, the pin holder comprising at least one pin which is complementary to the lamp sockets and a contact surface, the at least one pin extending from the contact surface, wherein the at least one pin extend from the pin holder, the pin holder being adapted to transmit current from the lighting fixture to the neon tubes when the wires of an electrode contact the contact surface.

The pin holder is the part that is connected to a lamp socket of a fluorescent lamp fixture. The pin holder has preferably a cylindrical shape with an open end and a closed end. The open end receives the end of a collar. The collar has a cylindrical shape, with an end comprising ribs on the external surface of the collar. The collar is adapted to receive an electrode of a neon tube through the end opposite the end comprising the ribs. It is possible to add a shoulder inside the collar to limit the movement of the electrode inside the collar. The collar is preferably made from a flame retardant material, such as Pyrolene™. The material is also preferably somewhat resilient.

The internal surface of the pin holder comprises ribs matching the ones on the collar to secure the connection. On the closed end of the pin holder, there is at least one pin that extends outwardly.

It is to be noted that the adapter may be made from a single part. Indeed, instead of having a distinct collar that has to be inserted into the pin holder, the pin holder may comprise an annular extension providing an adequate electrical insulation for the electrodes. The neon electrode is then simply inserted into said pin holder.

The pin(s) is(are) a metallic element transmitting the current from the lamp socket to the electrodes of the neon tube. The pin holder comprises means to electrically connect the pin to the neon electrode. The means to electrically connect the pin(s) adapter may be a contact surface from which at least one pin extends from the contact surface. The contact surface is in contact with the wires of a neon electrode. Thus when the pin holder is connected to a lamp socket, the current will be transmitted through the pin(s) and the contact surface to the neon tube. The means to electrically connect the pin adapter may be also, for example, wires connecting the pin to the neon electrode.

Different pin holders may be provided match different types of lamp sockets. For example, the pin holder may have one or more pins and the pins may have different shapes.

In the case of a neon adapter with a pin holder having a contact surface and a collar, an adapter is connected at each extremity of the neon tube. The wires of an electrode are twisted together to form a single twisted wire and are inserted into the collar through the end that does not comprise ribs. This single twisted wire is bent over the external side of the collar. The single twisted wire is cut to the first rib of the collar so that when the pin holder is connected to the collar, the wires are enclosed in the pin holder to prevent electrical shock. The collar is inserted into the pin holder so that the single twisted wire contacts the contact surface of the pin holder.

The same steps are carried out for both extremities of a neon tube. Prior to the installation of the neon tube into a fluorescent lamp fixture, the pins of both sides should be positioned to be in line with each other. The neon tube may then be inserted in the fluorescent lamp fixture as if it were a fluorescent tube. To facilitate the positioning of the different parts, it is possible to add indicators on the neon tube, the pin holder and the collar. The different parts are then aligned together during the installation.

Fluorescent tubes are usually provided in standard length. Similarly, neon tubes adapted to fit to these standard lengths may be used with the present invention. However, the actual neon tube used with the adapter of the present invention will be somewhat shorter because the adapter at each extremity of the neon tube is somewhat larger than the corresponding fluorescent tube connectors.

As specified above, in the present invention, the term ‘neon tube’ refers to an elongated cold cathode gas discharge tube containing an ionizable gas (including neon, argon, krypton and other gases or combinations). The tube has a pair of cathode elements passing through the glass at each end of the tube that are in contact with the gas. The cathode elements are connected to a power supply source, providing a high voltage between the cathode elements thus causing the gas to ionize and glow and producing the desired illumination. The traditional fluorescent tubes are excluded from this definition. Traditional fluorescents tubes refer to a lighting device usually of the hot cathode type, which generates ultraviolet light emitted by mercury vapor so that a phosphor coating absorbs the energy of the ultraviolet light and produces visible light. “Neon” tubes do not usually contain mercury (or at the very least significantly less than fluorescent tubes).

As explained above, the color of the light which is emitted when a high electric potential is applied across the electrodes depends on the particular inert gas with which the tube is filled.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of an embodiment of the adapter having two pins.

FIG. 2a is perspective view of a pin holder having two pins.

FIG. 2b is perspective view of a contact surface from which two pins extend.

FIG. 2c is a cross-side view of the pin holder of FIG. 2a.

FIG. 3 is a cross-side view of the embodiment of FIG. 1.

FIG. 4a is a perspective view of another embodiment of the present invention having a single pin adaptor.

FIG. 4b is a cross-side view of the embodiment of FIG. 4a.

FIG. 4c is a perspective view of the single pin of FIGS. 4a and 4b.

FIG. 4d is a cross-side view of the single pin of FIGS. 4a and 4b.

FIG. 5a is a perspective view of a pin holder having a rectangular pin.

FIG. 5b is a cross-side view of the embodiment of FIG. 5a.

FIG. 5c is a cross-side view of an embodiment of a pin holder for a rectangular pin holder.

FIGS. 5d and 5e are cross-side views of an embodiment of the adapter having a rectangular pin adaptor.

FIGS. 6a to 6c are schematic views showing the steps to connect the adapter.

FIG. 7 is a cross-view of a further embodiment of the pin holder.

### DETAILED DESCRIPTION OF THE PREFERRED EMBODIMENT

A novel adapter will be described hereinafter. Although the invention is described in terms of specific illustrative embodiment(s), it is to be understood that the embodiments) described herein are by way of example only and that the scope of the invention is not intended to be limited thereby.

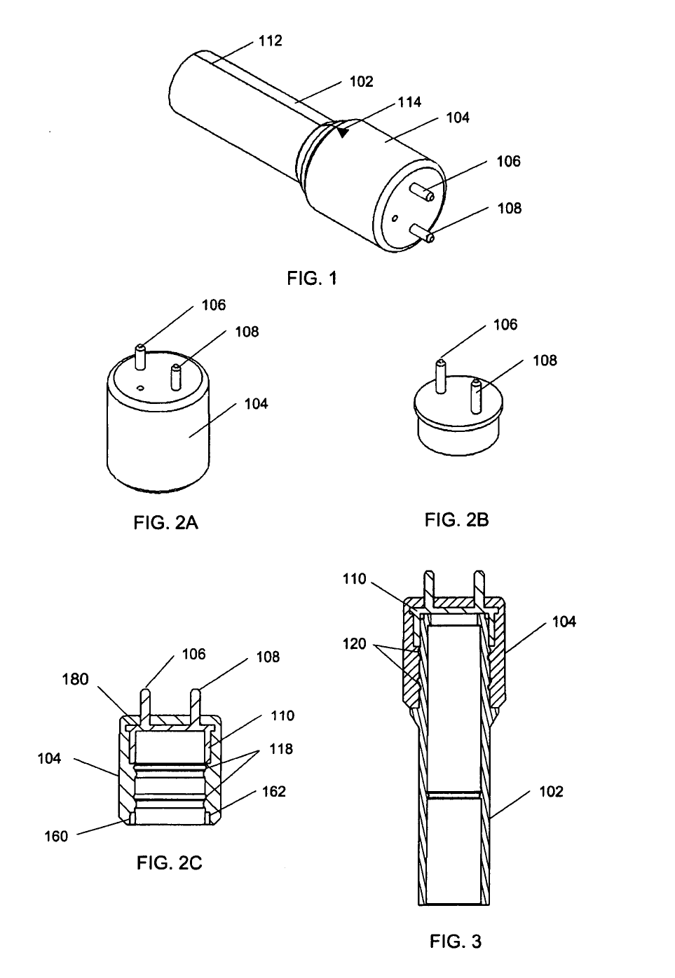

As shown in the embodiment of FIG. 1, the adapter comprises a collar 102, a pin holder 104 two pins 106 and 108. The pin holder 104 and the collar 102 are aligned along the collar alignment indicator 112 and the pin holder alignment indicator 114. The neon tubes that are used with the adapter may be marked at each extremity so that the pin holders are symmetrically installed at each end.

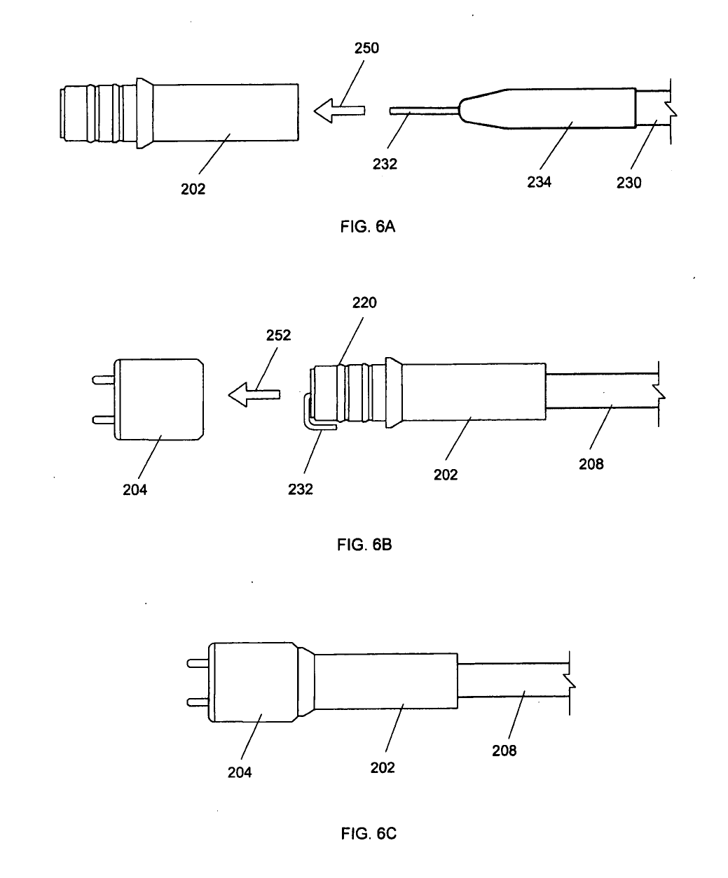

The pin holder 104 is shown in more details in FIGS. 2a to 2c. The pins 106 and 108 extend from the closed end of the pin holder 104 through holes made for this purpose in the pin holder 104. The pin holder 104 comprises two notches 160 and 162 that are used to align the wires of a neon tube (see FIG. 6 for more details). This pin holder comprises a contact surface 180.

As seen in FIG. 3, the collar 102 and the pin holder 104 have locking means; the complementary ribs (respectively 120 and 118) to secure the connection between the collar 102 and the pin holder 104.

The collar 102 and the pin holder 104 are made of a material which is preferably slightly resilient to be able to connect the different parts together and to the electrode of a neon tube. This material is preferably also flame retardant.

The pins are made from a metallic material which is capable of conducting electricity from the lamp fixture to the neon tube electrodes through the pins and the contact surface.

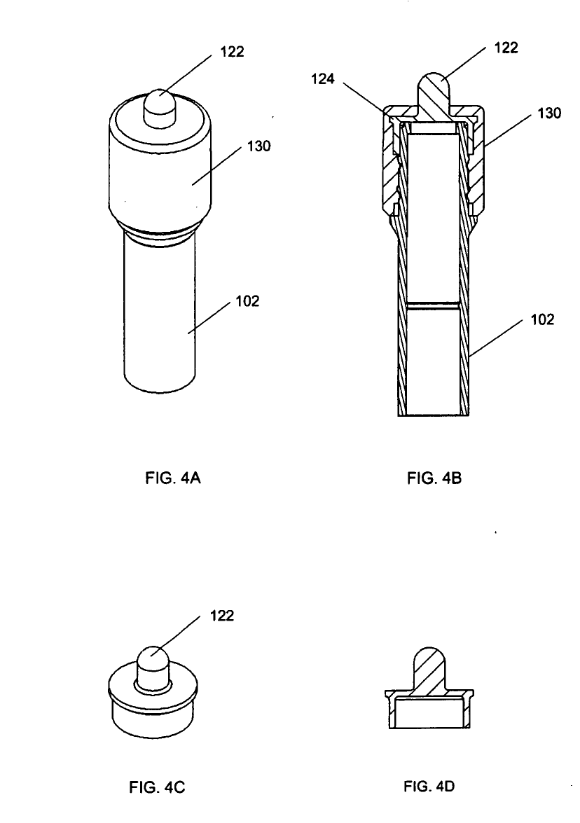

FIGS. 4a to 4b show another embodiment of the adapter having a single pin holder 130. The single pin holder 130 comprises a single pin 122. As explained for the previous embodiment, the single pin 122 extends from the pin holder 130.

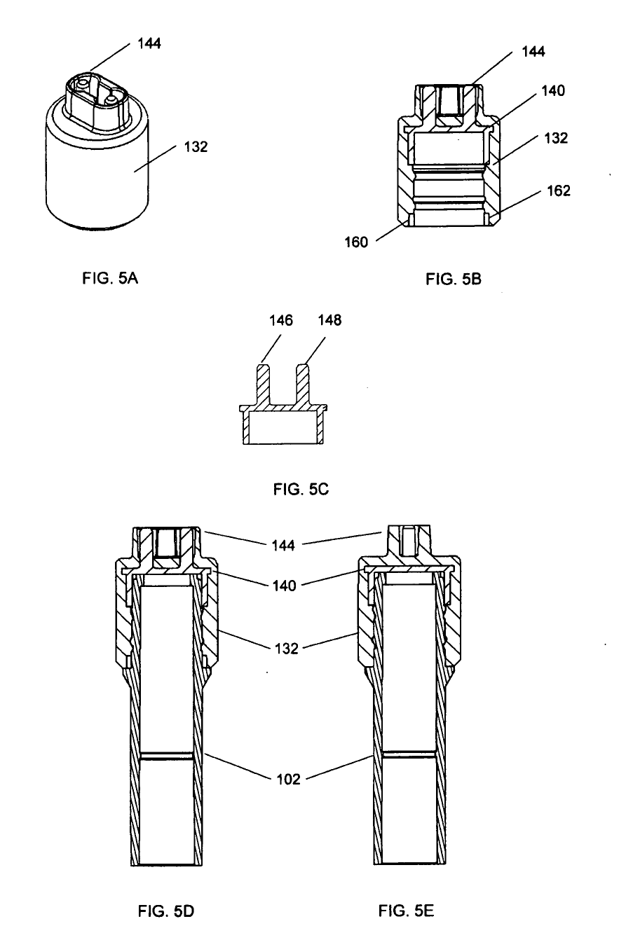

FIGS. 5a to 5c show another embodiment of the adapter having a rectangle pin holder 132. The rectangle pin holder 132 comprises two pins 146 and 148, comprised in the rectangle pin portion 144 of the pin holder 132.

The steps to connect a neon tube to an adapter are shown in FIGS. 6a to 6c. Both wires of the electrode 234 of the neon tube 230 are twisted in order to obtain a single twisted electrode wire 232. The electrode 234 is then slid into the collar 202 following the arrow 250.

Referring now to FIG. 6b, the twisted electrode wire 232 is bent back onto the side of the collar 202, in line with the collar alignment indicator (shown in FIG. 1). The twisted electrode wire 232 should not exceed the first locking rib 220 of the collar 202.

The twisted electrode wire 232 should be aligned with one of the notches (shown in FIG. 1) that are on the internal surface of the pin holder 204 prior to inserting the collar 202 into the pin holder 204. One of the notches is in line with the pin holder alignment indicator. The pin holder 204 and the collar 202 are then connected together and the twisted electrode wire 232 contacts the contact surface of the pin holder.

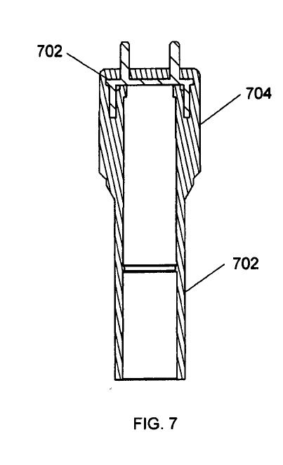

FIG. 7 shows the pin holder wherein the collar 702 and the pin holder 704 are unitary. The neon electrode (not shown) is then simply inserted in the pin holder and the wires of the electrode contact the contact surface 702 of the pin holder or may be welded or otherwise electrically connected thereto.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art. For example, the actual means used to electrically connect the electrodes to the pins could vary without departing from the spirit of the invention.

1. An adapter for a cold cathode gas discharge tube of the type comprising a tube containing a noble gas but excluding fluorescent tubes, a pair of electrodes located inside said tube and wires extending through the tube to electrically connect each said electrode to said adapter, said adapter being used to install said neon tube into a lighting fixture of the type adapted to receive traditional fluorescent tubes, said fixture having lamp sockets, said adapter comprising:
a) a pin holder, said pin holder comprising at least one pin which is complementary to said lamp sockets;
b) means to attach said pin holder to said discharge tube;
c) means to electrically connect said pin to said electrode of said discharge tube.

2. The adapter of claim 1, wherein said means to electrically connect said pin holder to said electrode is a contact surface made from a conductive material from which said pin of said pin holder extends, said wires of said electrodes being adapted to be in contact with said contact surface.

3. The adapter of claim 1, wherein said means to electrically connect said pin holder to said electrode are wires that are in contact with said pin of said pin holder, said wires of said electrodes being in electrical contact with said wires of said pin holder.

4. The adapter of claim 1, further comprising a collar portion, said collar portion receiving said neon electrode and said collar being inserted into said pin holder.

5. The adapter of claim 4, wherein external surface of said collar comprises first locking means.

6. The adapter of claim 5, wherein said first locking means comprises at least one rib.

7. The adapter of claim 6, wherein internal surface of said pin holder comprises second locking means cooperating with said first locking means.

8. The adapter of claim 7, wherein internal surface of said pin holder comprises at least one channel cooperating with said at least one rib.

9. The adapter of claim 8, wherein said wires are bent on external side of said collar and wherein said wires are cut so that they do not got further than said first locking means.

10. The adapter of claim 1, wherein said pin holder is made of a flame retardant material.

11. The adapter of claim 4, wherein said collar is made of a flame retardant material.

12. The adapter of claim 11, wherein said pin holder is made from Pyrolene™.

13. The adapter of claim 1, wherein said pin holder further comprises a pin holder alignment indicator.

14. The adapter of claim 4, wherein said collar further comprises a collar alignment indicator.

15. An adapter for a gas tube of the type comprising a tube containing a noble gas which produce visible light when ionized, a pair of electrodes located inside said tube near a respective end of said tube and wires extending through the tube while electrically connecting each said electrode, said adapter being used to install said gas tube into a lighting fixture of the type adapted to receive traditional fluorescents tubes, said fixture having lamp sockets, said adapter comprising:
a) a pin holder, said pin holder comprising at least one pin which is complementary to said lamp sockets;
b) means to attach said pin holder to said gas tube;
c) means to electrically connect said pin to said electrode of said gas tube.

16. The adapter of claim 15, wherein said means to electrically connect said pin holder to said electrode is a contact surface made from a conductive material from which said pin of said pin holder extends, said wires of said electrodes being in contact with said contact surface.

17. The adapter of claim 15, wherein said means to electrically connect said pin holder to said electrode are wires that are in contact with said pin of said pin holder, said wires of said electrodes being in contact with said wires of said pin holder.

18. The adapter of claim 15, further comprising a collar, said collar receiving one of said tube ends and said collar being inserted into said pin holder.

19. The adapter of claim 18, wherein external surface of said collar comprises first locking means.

20. The adapter of claim 19, wherein said first locking means comprises at least one rib.

21. The adapter of claim 20, wherein internal surface of said pin holder comprises second locking means cooperating with said first locking means.

22. The adapter of claim 21, wherein internal surface of said pin holder comprises at least one channel cooperating with said at least one rib.

23. The adapter of claim 22, wherein each said wire is bent over the external side of said collar and wherein said wire is cut so that they do not got further than said first locking means.

24. The adapter of claim 15, wherein said pin holder is made of a flame retardant material.

25. The adapter of claim 18, wherein said collar is made of a flame retardant material.

26. The adapter of claim 25, wherein said pin holder is made from Pyrolene™.

27. The adapter of claim 15, wherein said pin holder further comprises a pin holder alignment indicator.

28. The adapter of claim 18, wherein said collar further comprises a collar alignment indicator.

29. An adapter for a cold cathode gas discharge tube of the type comprising a tube containing a noble gas, an electrode located inside said tube near each tube end and wires extending through the tube to electrically connect each said electrode, said adapter being used to install said discharge tube into a lighting fixture of the type adapted to receive fluorescents tubes, said lamp having lamp sockets, said adapter comprising:
a) a collar having a complementary shape to that of said tube, said collar adapted to receive one of said tube ends;
b) means to attach said pin holder to said discharge tube;
c) a pin holder, said pin holder comprising at least one pin which is complementary to said lamp sockets and a contact surface, said at least one pin extending from said contact surface, wherein said at least one pin extend from said pin holder, said pin holder being adapted to be transmit current from said lighting fixture to said neon tubes when said wires of a said electrode contact said contact surface.

30. The adapter of claim 29, wherein said wires of one said electrodes are twisted together to form a single twisted wire, said twisted wire being bent over one external side of said collar.

31. The adapter of claim 30, wherein said single twisted wire has a length such that said twisted electrode is comprised within said pin holder.

32. The adapter of claim 29, wherein external surface of said collar comprises first locking means.

33. The adapter of claim 32, wherein said first locking means comprises at least one rib.

34. The adapter of claim 32, wherein internal surface of said pin holder comprises second locking means cooperating with said first locking means.

35. The adapter of claim 33, wherein internal surface of said pin holder comprises at least one channel cooperating with said at least one rib.

36. The adapter of claim 32, wherein each said wire is bent over an external side of respective said collars and wherein said wires are cut so that they do not got further than said first locking means.

37. The adapter of claim 29, wherein said collar and said pin holder are made of a flame retardant material.

38. The adapter of claim 37, wherein said collar and said pin holder are made from Pyrolene™.

39. The adapter of claim 29, wherein said collar further comprises a collar alignment indicator.

40. The adapter of claim 29, wherein said pin holder further comprises a pin holder alignment indicator.
